(19) United States
(12) Patent Application Publication
(10) Pub. No.: US 2008/0030573 A1
(43) Pub. Date: Feb. 7, 2008

(54) VOLUMETRIC PANORAMIC SENSOR SYSTEMS

(76) Inventor: Kurtis J. Ritchey, Leavenworth, KS (US)

Correspondence Address: CARDINAL LAW GROUP, Suite 2000, 1603 Orrington Avenue, Evanston, IL, 60201, US

(21) Appl. No.: 11/829,696

(22) Filed: Jul. 27, 2007

Related U.S. Application Data
(63) Continuation of application No. 11/432,568, filed on May 11, 2006.

(51) Int. Cl. H04N 7/00

(52) U.S. Cl. 348/36; 348/E09.002

(57) ABSTRACT

A volumetric sensor assembly comprising a single strip of material that has been twisted such that light sensitive recording regions face in a plurality of directions, optics associated with each region to record a portion of the panoramic scene, and a processor to read out the signal associated with light sensitive regions input signal or power to the sensor.

### RELATED APPLICATIONS

This is a Continuation Application of U.S. Patent Publication Serial No. 11/432,568 entitled “Volumetric Panoramic Sensor Systems” and filed May 11, 2006

### FIELD OF THE INVENTION

This invention relates to the field of non-planar volumetric data processing and/or processing devices. And more specifically, the present invention relates to non-planar sensing systems and methods for recording and processing panoramic FOV imagery. The invention also relates to the method of construction, fabrication, and manufacturing of such electronic devices, such as CMOS, CCD, and PCB's, in a non-planar way. Finally, this invention has to do with panoramic and spherical FOV imaging systems and associated processing and audio-visual/display systems to enable panoramic viewing by a user/participant.

Additionally, the present invention generally relates to panoramic camera, processing, and display systems. Specifically, electronic paper display systems.

### BACKGROUND OF THE INVENTION

Initially Jaron Lanier invented graphical based “virtual reality” in the late 1970's, “VR” for short. U.S. Pat. No. 4,656,506 to Ritchey (hereinafter the “Ritchey '506 Patent”), the entirety of which is hereby incorporated by reference, expanded on the VR idea by using a plurality of six cameras to form a spherical FOV image. The Ritchey '506 Patent's using 360-degree panoramic camera imagery added increased reality to the concept of virtual reality pioneered by Jaron Lanier. U.S. Pat. No. 5,130,794 to Ritchey (hereinafter the “Ritchey '794 Patent”), the entirety of which is hereby incorporated by reference, discloses a single camera with optical means for reflecting images representing spherical FOV coverage to an off axis image plane. It was also recognized by those skilled in the art a combination of the two was camera and off axis image reflection could be used to simultaneously record imagery of spherical panoramic content. The Ritchey '794 Patent illustrates the prior art concept and arrangement of using a plurality of cameras to record a panoramic scene. In the mid-to-late 1980's, the term “image based virtual reality” or “IBVR”, “IMVR” or Telepresence was used to describe the technology were panoramic video imagery was recorded, processed, and displayed to the viewer to give the user/participant the feeling of being immersed in a audio-visual and textual environment. Image based virtual reality was an improvement in realism over graphical representations. The present inventor used off-the-shelf television computer driven special effects devices to process the two or more hemispherical images into an immersive scene that could be interactively displayed to the participant viewer. Examples of this in the 1980's and 1990's included Quantel's Harry System (i.e., U.S. Pat. No. 4,334,245 to Michael, the entirety of which is hereby incorporated by reference), Sony's Digital Production Suite, and Trinity's Play digital video effects workstation system. These systems were capable of manipulating panoramic camera images from a single or multiple cameras and manipulating the video for panoramic viewing. Additionally, the Ritchey '794 the use of videowalls in a novel way to form immersive “video rooms” or “reality rooms” that surrounded the viewer with a panoramic scene. Video rooms were simply panoramic scenes viewer watched and listened to, while reality rooms were rooms the viewer could interact with using interactive input devices. Additionally, the present inventor disclosed the immersive viewing of panoramic scenes by using an HMD the Ritchey '794 Patent and the telecommunication of substantially spherical FOV imagery scenes in whole or in part in U.S. Pat. No. 5,495,576 to Ritchey (hereinafter the “Ritchey '576 Patent”), the entirety of which is hereby incorporated by reference,

Other efforts in the filed provided a panoramic field-of-view (FOV) coverage camera that used a single wide angle lens and camera. U.S. Pat. No. 5,186,667 to Zimmerman (hereinafter the “Zimmerman '667 Patent”) and U.S. Pat. No. 5,877,801 to Martin (hereinafter the “Martin '801 Patent”), the entirety of both being hereby incorporated by reference, disclose a camera and fisheye about 1988 to pan and zoom in on a hemispherical image under a NASA SBIR grant. Inventor Ford Oxaal took it one step further by inventing a camera rotator to record two hemispherical images one-after-the-other with a film camera, and then digitizing the still image in a computer and software to stitch the images together to form a spherical image in about 1992. They and others were simultaneously developing PC and computer workstation processing hardware and software for use in manipulating the panoramic imagery they recorded with their respective panoramic camera systems. For instance Helmet Dersch, of Germany was the first to invent “PanoTools” for removing barrel distortion, stitching and viewing panoramic imagery recorded by still cameras. Similarly, as mentioned above, Ford Oxaal and Omniview developed single film camera and later video software for removing barrel distortion, stitching, and viewing. Formerly Omniview, now IPIX, BeHere, and IMOVE developed barrel distortion, stitching, and viewing software for removing distortion, stitching, and viewing software.

U.S. Pat. No. 5,023,725 to McCutchen (hereinafter the “McCutchen '725 Patent”), the entirety of which is hereby incorporated by reference, discloses a panoramic camera system for recording panoramic images in which each dodecahedral face includes a panoramic camera. The camera head was spherical shaped and about nine inches in diameter. The size of the sensor limited its portability. In 2000, McCutchen incorporated conventional HDTV in a very similar way. The HDTV sensors made the camera very expensive but useful for recording a high resolution FOV panoramic camera. McCutchen also incorporated production software for stitching imagery recorded from his panoramic camera system.

Since those early inventions other patents have disclosed similar approaches. All of these approaches have incorporated conventional off the shelf technology to record panoramic imagery that has less than or up to spherical FOV coverage.

Increasingly, since about 1995 onward, great progress has been made in conventional planar CCD and CMOS image sensors. Specifically, integrated circuit technology has evolved that allows smaller sensors of high resolution. Additionally, some specialized sensors have been developed that allow ROI windowing and target tracking onboard the chip. These chips include special circuitry that allows imagery recorded by an individual pixel or group of pixels within the imaging array to be read out. Once read out the image signals may be processed on-chip, sent to a processing chip on the same or an adjacent printed circuit board, or to an adjacent computer for processing. Examples of these ROI chips and processors can be found in JPL, Nova, Dalsa, and Photonic Vision Systems (PVS), Inc. image sensors, just to name a few exemplary examples. Examples of a PVS CMOS selective pixel readout circuitry has been provided by Silicion Video Inc. and U.S. Pat. No. 6,084,229 to Pace (hereinafter the “Pace '229 Patent”), an entirety of which is hereby incorporated by reference, teaches a semi-conductor device of a type that is integrated and adapted in the present invention to form a volumetric panoramic sensor device. U.S. Pat. No. 5,541,654 to Roberts (hereinafter the “Roberts '654 Patent”) and U.S. Patent Publication No. 2004/0095492 to Baxter (hereinafter the “Baxter Publication”), the entirety of both being hereby incorporated by reference, illustrate CCD and CMOS semiconductor devices with region of interest capabilities of a type that is integrated and adapted in the present invention to form a volumetric panoramic sensor devices.

U.S. Pat. No. 6,791,072 to Prabhu (hereinafter the “Prabhu '072 Patent”); U.S. Pat. No. 6,752,888 to Hosier (hereinafter the “Hosier '888 Patent”); U.S. Pat. No. 5,510,273 to Quinn (hereinafter the “Quinn '273 Patent”); U.S. Pat. No. 6,287,949 to Mori (hereinafter the “Moir '949 Patent”); and U.S. Pat. No. 5,907,770 to Yamazaki (hereinafter the “Yamazaki '770 Patent”), the entirety of all being hereby incorporated by reference, teach methods for constructing curved and continuous CCD, CMOS and PCB sensor arrays of type have been integrated and adapted in the present invention to form a volumetric panoramic sensor device. Heretofore CCD and CMOS construction has been on planar surfaces. The recent disclosures in prior art teach how to etch, laminate, and lithographize circuitry onto a non-planar silicon chip enables the construction of a continuous circuit being placed on a non-planar chip or non-planar printed circuit board. U.S. Pat. No. 6,416,908 to Klosner (hereinafter the “Kloser '908 Patent”); the Yamazaki '770 Patent”); U.S. Pat. No. 6,624,429 to Wolfe (hereinafter the “Wolfe '429 Patent”); and U.S. Pat. No. 6,489,992 to Savyoe (hereinafter the “Savyoe '992 Patent”), the entirety of all being hereby incorporated by reference, demonstrate this enabling technology. U.S. Pat. No. 6,563,101 to Tullis (hereinafter the “Tullis '101 Patent”), the entirety of which is hereby incorporated by reference, has a panoramic volumetric sensor array system that discloses an image tracking device in which an imaging array covers only a portion of the surface. The array is not used for panoramic photography or video recording but for image tracking. In contrast the present invention discloses a system for panoramic photography and video recording, processing, and display. Additionally the present invention discloses a system for completely covering a volumetric shape, not just a “portion” of an object. Full volumetric arrays present a greater challenge than just covering a small portion of an object with a sensor. Correspondingly, unlike the system disclosed by Tullis, the present invention discloses a corresponding optical assembly that can go on a full volume sensing array. The present invention discloses a method of manufacturing a single volumetric device that has IC, heat syncs, fans, support armature, optics, protective cover, and so forth and so on required to form such a device.

U.S. Patent Publication No. 2003/0141433 to Gordon (hereinafter the “Gordon Publication”); and U.S. Patent Publication No. 2005/0007477 to Ahiska (hereinafter the “Ahiska Publication”), the entirety of both being hereby incorporated by reference, discloses the incorporation of ROI, windowing, distortion removal, image stitching, light intensity control, motion control, and image processing and readout.

U.S. Pat. No. 4,334,245 to Michael (hereinafter the “Michael '245 Patent”); U.S. Pat. No. 5,684,937 to Oxaal (hereinafter the “Oxaal '937 Patent”); U.S. Pat. No. 6,535,630 to Poulo (hereinafter the “Poulo '630 Patent”); and U.S. Patent Publication No. 2004/0196282 to Oh (hereinafter the “Oh Publication”), the entirety of all being hereby incorporated by reference, illustrate prior art software available to manipulate of spherical FOV imagery captured by present invention improved panoramic camera designs by the present inventions volumetric camera systems.

Furthermore, the present invention discloses the use of the volumetric sensor as an input device to other processing and display devices such as conventional displays, HMDs, room and theater audio-visual systems. The present invention incorporates recently developed CCD and CMOS technology to create a new generation of panoramic image sensors. And more generally, the technology can be adapted to create a new generation of compact IC and PCB devices. While examples are provided in which the volumetric IC's and PCB include sensors that gather signatures of the surrounding environment, the IC's and PCB's of the present invention do not necessarily have to include sensors. The design of an IC and PCB in a compact geometric according to the present invention in of itself can provide efficiencies not found in flat IC and PCB designs.

Finally, display devices such as CRT's have continued to become more compact with the advent of flat and thin panel displays. In particular, room displays, or reality rooms and video rooms which incorporated rear screen projection disclosed in the Ritchey '794 Patent and by others have required a lot of space. And front screen projections inside a video room or reality room or CAVE or DOME system have cast shadows if the viewer blocks projection, causing interference in viewing and the sense of immersiveness the viewer experiences. New electronic paper displays and thinner LED displays used for billboards allow the need for projection space to be elevated.

The Ritchey '506 Patent; U.S. Patent Publication No. 2002/0156858 to Hunter (hereinafter the “Hunter Publication”); U.S. Patent Publication No. 2003/0192213 to O'Connell (hereinafter the “O'Connell Publication”); 2004/0021617 to Blum (hereinafter the “Blum I Publication”); U.S Patent Publication No. 2004/0001002 to Blum (hereinafter the “Blum II Publication”); U.S. Patent Publication No. 2004/0113865 to Oku (hereinafter the “Oku Publication”); U.S. Patent Publication No. 2005/0007336 to Albert (hereinafter the “Albert Publication”); and U.S. Patent Publication No. 2004/021787 to Kokonashi (hereinafter the “Kokonashi Publication”), the entirety of all being hereby incorporated by reference, is integrated and adapted in the present invention to form improved video room and reality room display systems. Additionally, U.S. Pat. No. 5,724,758 to Gulick (hereinafter the “Gulick '758 Patent”); and U.S. Pat. No. 2,833,176 to Ossoinak (hereinafter the “Ossoinak '176 Patent”) the entirety of both being hereby incorporated by reference is integrated and adapted in the present invention that is integrated in the present example to form autostereoscopic CCD, CMOS, and correspondingly autostereoscopic video room and reality room display systems. Correspondingly, prior art distribution systems of the Ritchey '794 Patent; U.S. Patent Publication No. 2003/0076484 to Bamji (hereinafter the “Bamji Publication”); and U.S. Pat. No. 6,816,132 to Tanijiri (hereinafter the “Tanijiri '132 Patent”), the entirety of all being hereby incorporated by reference, distribute imagery recorded by volumetric sensor systems to panoramic room or HMD display systems.

### SUMMARY OF THE INVENTION

The present invention is a volumetric sensor assembly comprising optics associated with light sensitive recording regions for recording a panoramic scene, and a processor to read out at least one signal associated with the light sensitive recording regions. In one form, a single strip of material is twisted into a configuration of the light sensitive recording regions facing in a plurality of directions. In a second form, a single integrated polyhedral shaped device includes plurality light sensitive recording regions incorporated as a single integrated unit. In a third form, a single integrated circularly shaped device including a plurality of light sensitive recording regions incorporated as a single integrated unit.

With the growing and projected increase in panoramic field-of-view imagery and the advances in sensor technology, there is good reason to evolve the design a sensor specifically for panoramic FOV camera imaging systems. It is therefore the intent of the present invention to disclose a panoramic image sensor. It is also an objective to include as part of that image sensor processing means. It is furthermore the intent of the present invention to include firmware for use with that processing means to remove optical distortion, movement distortion, target tracking/ROI tracking, position sensing, stitching, scaling, clipping, video readout, multiplexing, viewing, and the like to enable viewing of the recorded image signal or signals. It is also an objective to disclose means for constructing said panoramic image sensor. It is a further objective to provide a sensor of various shapes to facilitate various panoramic recording. It is also an objective to provide a chip responsive to various resolution requirements, and to create a sensor that is compact to portability, close in adjacent FOV lens coverage, and cost efficient to manufacture. The present invention teaches a novel and improved system and method for recording and processing panoramic imagery. And related to this, the invention of a non-planar image processing or data processing device and method of making that device is provided in the present invention. A single integrated three-dimensional imaging or data processing device is disclosed herein and preferably in the form of a volumetric Charge Coupled Device and/or volumetric CMOS device and/or printed circuit board are disclosed herein.

Other objectives of the present invention include using electronic paper and thin LED's to form immersive room displays for viewing spherical FOV imagery captured by the improved panoramic camera systems and panoramic volumetric sensor devices put forth in the present invention. Correspondingly a method to create an autostereoscopic display system is provided to provide a realistic unencumbered room display system. Also correspondingly, several improved distribution methods and image control systems are put forth for distributing the panoramic images over a telecommunications system and for dividing up the image locally across displays that form a room or head mounted display system. Also, a method to hide the entry and exit of room display systems is provided to improve the immersive feeling the viewer experiences and at the same time allow large audience unencumbered egress in and out of the viewing space.

Finally, several specific applications are put forth in the present invention for using the panoramic camera, processing, and display systems of the present invention as part of a vehicular observation system, a diagnostic system that is a pill or endoscope, and finally in a robotic or remotely piloted vehicle system.

### DRAWINGS OF THE PRESENT INVENTION

FIG. 1 is a perspective and diagrammatic view of a panoramic autostereoscopic sensor, recording, processing, and display system embodiment representative of the present invention.

FIGS. 2A-2C are diagrams respectively illustrating an undistorted image, barrel distortion, and pincushion distortion.

FIG. 3 is a perspective drawing of the optical components of a panoramic spherical FOV imaging system coupled with an image sensor with ROI processing in order to achieve selective viewing of any portion or portions of the captured hemispherical images that constitute spherical FOV coverage in accordance with the present invention.

FIG. 4 is a perspective drawing providing an arrangement optical components using Fibreye™ to achieve reduced distortion panoramic spherical FOV imaging coupled with an image sensor with ROI processing in order to achieve selective viewing of any portion or potions of the captured hemispherical images that constitute spherical FOV coverage in accordance with the present invention.

FIG. 5 is a perspective drawing providing an arrangement of optical components like that illustrated in FIG. 3, but further including fiber optic image conduits with an off-axis optical path to bend the reflected image toward the image sensor array.

FIGS. 6A-C are diagrammatic drawings showing various applications/embodiments of panoramic volumetric sensors according to the present invention.

FIG. 7 is a functional diagram illustrating the algorithms/processes of an exemplary embodiment of the panoramic volumetric sensor array system conducts according to present invention.

FIG. 8 is a diagram illustrating the components that comprise an exemplary embodiment of the panoramic volumetric sensor array system according to the present invention.

FIGS. 9A-C are diagrams respectively illustrating possible image frames (a) and (b) captured by an exemplary embodiment of the panoramic volumetric sensor array system in accordance with the present invention, and the subsequent image (c) process out for display.

FIG. 10 is a perspective diagram of the exemplary panoramic volumetric sensor device and associated optics imaging subjects (a) and (b), in concert with that described in FIG. 9.

FIGS. 11A-H are diagrams of variously shaped embodiments of panoramic volumetric sensor array devices according to the present invention.

FIG. 12A is a greatly enlarged perspective drawing of an exemplary panoramic volumetric sensor array device according to the present invention.

FIG. 12B is a greatly enlarged perspective cutaway drawing further illustrating some of the components and arrangement which make up the exemplary panoramic volumetric sensor array device according to the present invention.

FIG. 13A is a schematic diagram of the layout of the exemplary panoramic volumetric sensor array device with two discrete areas according to the present invention.

FIG. 13B is similar but different embodiment to FIG. 13A with eight discrete areas of the panoramic volumetric sensor array device according to the present invention.

FIGS. 14-17C illustrates various embodiments of manufacturing methods and circuitry layouts of panoramic volumetric devices for CCD, CMOS, and PCB's according to the present invention.

FIGS. 18 and 19 are side sectional views of electronic paper displays according to the present invention that form a surround room or theater that is supported pneumatically.

FIGS. 20A and 20B are diagrams of the major components of a panoramic volumetric sensor array that incorporates CMOS shape sensor arrays according to the present invention.

FIGS. 21A and 21B are views of an embodiment of the panoramic volumetric sensor system according to the present invention in which the sensor system has an associated transceiver for telecommunications with a remote processing and/or display device such as a HMD.

FIG. 22 is a perspective illustrating various methods of integrating the panoramic volumetric sensor array and other panoramic camera arrangements disclosed in the present invention onto a vehicle.

FIGS. 23 and 24 are block diagrams of the system architecture of the panoramic audio-visual system for a vehicle as described in FIG. 22 according to the present invention.

### DETAILED DESCRIPTION OF THE PRESENT INVENTION

Below is a detailed description of the present invention, which includes various embodiments. For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, and alterations and modifications in the illustrated device, and further applications of the principles of the disclosure as illustrated therein are herein contemplated as would normally occur to one skilled in the art to which the disclosure relates.

Overview of PCB or IC: In the broadest sense the present invention comprises a new class of electrical circuitry devices that can be implemented onto a printed circuit board (PCB) or integrated circuit (IC) substrate. The PCB or IC in the present invention can be constructed on conventional materials familiar to PCB or IC manufacturing. PCB's are typically constructed on plastic boards with conductive metal conductors integrated into the IC's to carry electrical charges. IC's are typically constructed using silicon for the base with other conductive metal conductors integrated into the IC's to carry electrical charges.

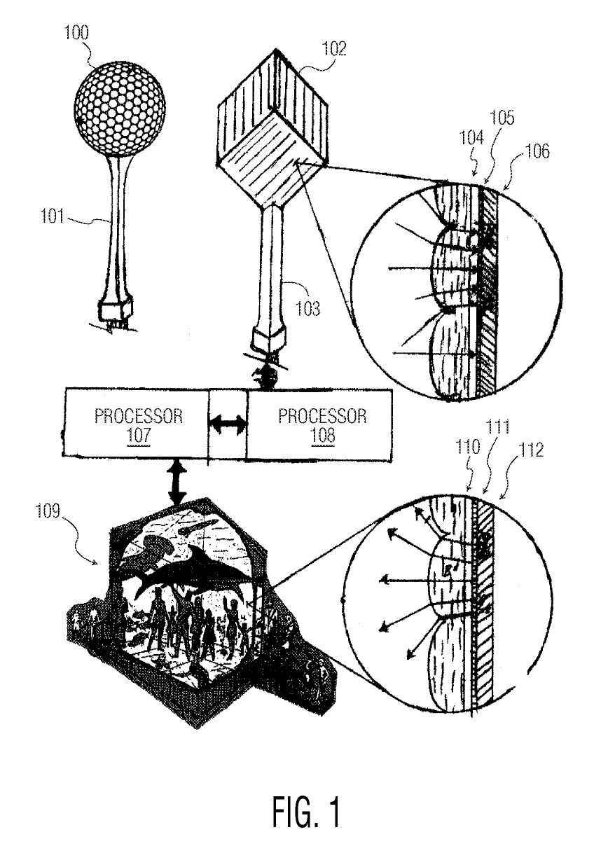

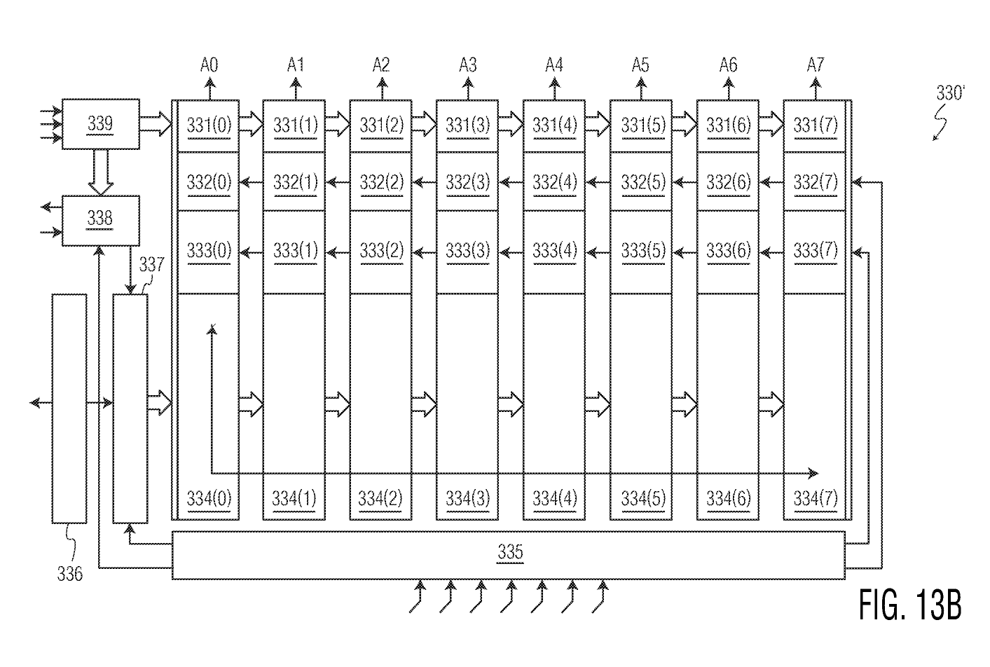

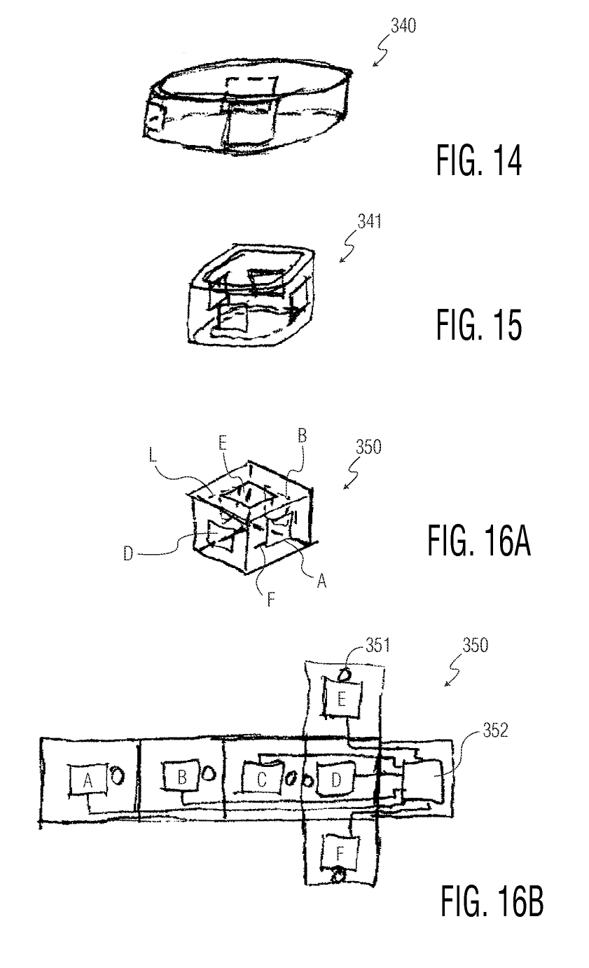

Fabrication: The PCB or IC device may be configured in any geometric shape or volume depending on its function. FIGS. 14-17 illustrate various embodiments of manufacturing methods and circuitry layouts of panoramic volumetric devices for CCD, CMOS, and PCB's according to the present invention. Circuitry and insulation material may be built up in layers, folded, connected, etched and so forth in traditional manners skilled to those familiar with the art to form the panoramic volumetric sensor device. However, special considerations such as handling must be considered in the manufacturing process so as not to damage the electrical components of the device. Therefore, during handling during manufacturing points for holding the device are constructed or armatures that extend from the device are used to rotate and move the device. For instance in FIG. 1, each respective sensor 100,102 is held in place by a mast or armature 101,103. The armature 101,103 may be used during the manufacturing process to orient the respective sensor 100,102 during etching, coating, heating, and other processes that are typically carried out during fabrication of the device.

Preferably the PCB or IC device is constructed in as tightly configured arrangement as possible in order accomplish its application. For instance, a sphere and cube are considered very efficient shapes because of their compactness of mass. Because of this circuitry can be designed to interconnect at various angles across the volume as taught by the Mori '949 Patent. Considerations in packing electrical circuitry in to a confined volume include heat build up. Another consideration in packing electrical circuitry into a small volume includes protection of the exterior of the device. This is especially true if the device has delicate electronics, such as sensors, positioned on or near its exterior surface. In such an instance, a cover (e.g., glass) is positioned over the device to protect it from hazards in the environment. The cover may be attached at places on the device substrate that do not interfere with electrical components. Heat syncs, small fans, and air spaces within the volumetric sensor are provided as required.

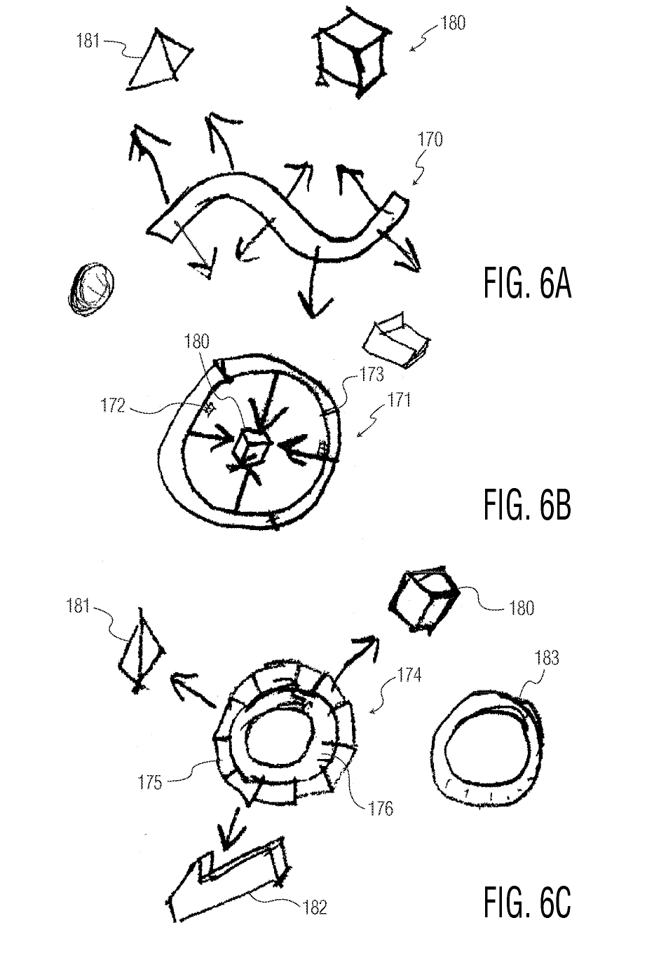

Camera System: I will now describe the preferred embodiment of the panoramic volumetric sensor array system. With the rapid evolution of digital imaging technology and data communication, the need or at least the desire to capture images and to electronically send and receive those images is increasing. To satisfy this need, image pickup devices, such as CCD and CMOS image sensors, have been utilized to help create the digital imaging industry. FIGS. 6A-6C are diagrammatic drawings showing various applications/embodiments 170,171,174 of panoramic volumetric sensors according to the present invention. Specifically, sensor 170 is a linear-like sensor array with an exterior field of view for picking up objects 180 and 181. Sensor 171 is a circular sensor having an inward looking field of view for picking up object 180. Heat sinks 172 and 173 are shown. Sensor 174 is a circular sensor having an outward looking field of view for picking up objects 180-183. Sensor array 175 and supporting substrate 176 are shown.

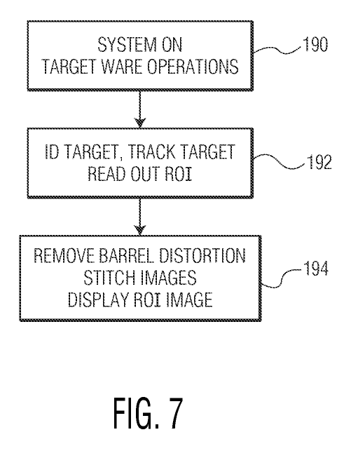

FIG. 7 is a functional diagram illustrating the algorithms/processes of an exemplary embodiment of the panoramic volumetric sensor array system conducts according to present invention. Specifically, a block 190 encompasses system being powered on by operator and all target software/firmware (e.g., target description, target identification and target tracking) becoming operational in memory. Block 192 encompasses a ID and tracking of the target with a ROI read out of the target. Block 194 encompasses a removal of barrel distortion from the ROI image, a stitching of images (if needed) and a display of the ROI image.

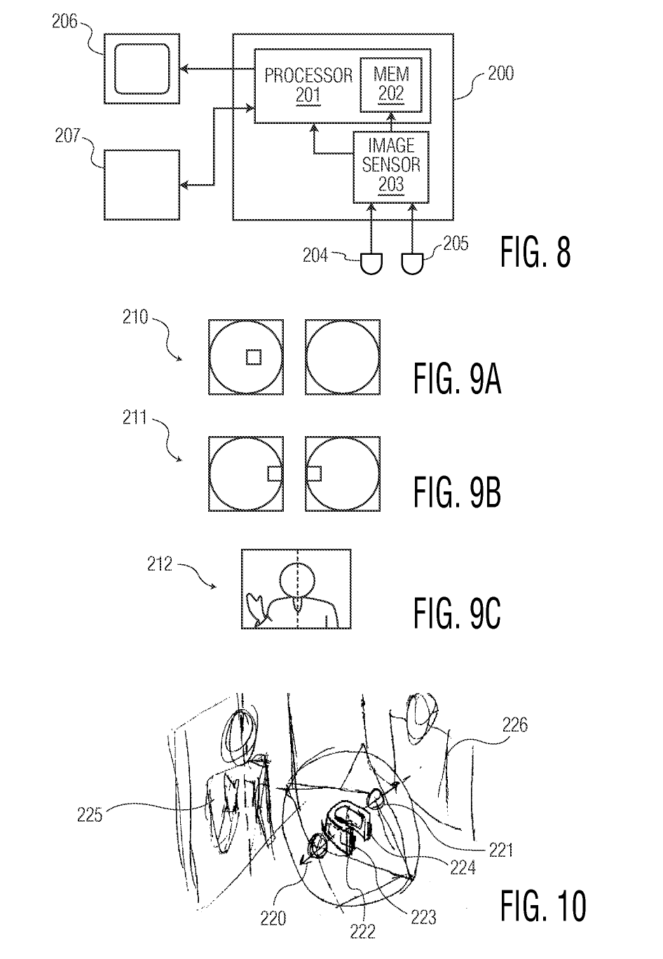

FIG. 8 is a diagram illustrating the components that comprise an exemplary embodiment of the panoramic volumetric sensor array system 200 according to the present invention for implementing FIG. 7. Specifically, system 200 employs an image/graphic processor 201, a memory 202, an image sensor 203 (e.g., CMOS/CCD), pan segments 204,205, a display 206, and an input/interface device 207.

FIGS. 9A-9C is a diagram illustrating possible image frames 210 and 211 captured by an exemplary embodiment of the panoramic volumetric sensor array system in accordance with the present invention, and the subsequent image 212 process out for display.

FIG. 10 is a perspective diagram of the exemplary panoramic volumetric sensor device and associated optics imaging subjects (a) and (b), in concert with that described in FIGS. 9A-9C. Specifically, the sensor employs fisheye lines 220,221, sensor array side 222 for image 225, sensor array side 224 for image 226 and electrodes 223.

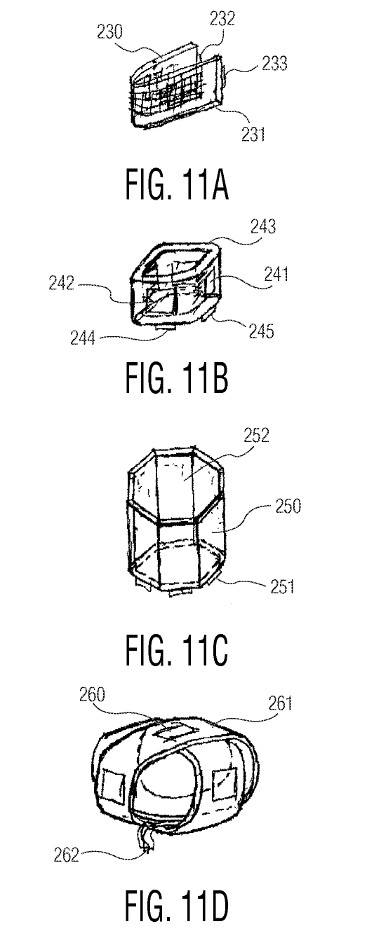

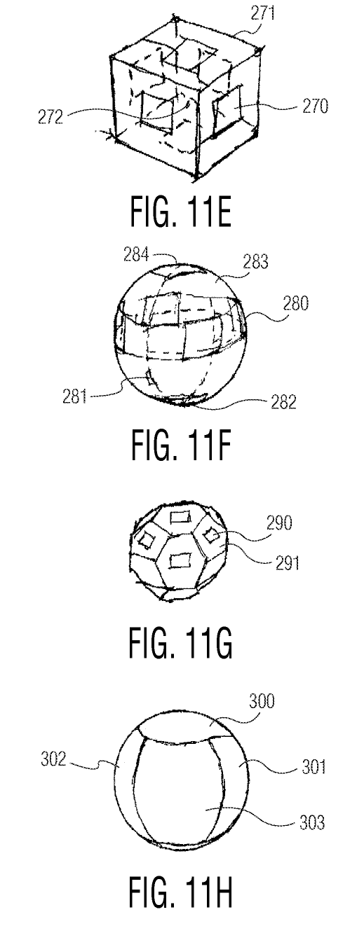

FIGS. 11A-11H is a diagram of variously shaped embodiments of panoramic volumetric sensor array devices. Specifically, FIG. 11A shows a U-shaped sensor employing a sensor array 230 with an electrode 232 and a sensor array with an electrode 233. FIG. 11B shows a square shaped sensor employing sensor arrays 240-243 with electrodes 244 and 245. FIG. 11C shows a octagonal shaped sensor with six (6) sensor arrays 250 supported by a substrate 252 and electrodes 251. FIG. 11D shows a twisted shape sensor having six (6) sensor arrays 260 supported by a substrate 261 and electrodes 262. FIG. 11E shows a cubical shape sensor having six (6) sensor arrays 270 supported by a substrate 271 and a cooling fan 272. FIG. 11F shows a spherical shape sensor having circular sequence of sensor arrays 280, sensor array 282,284 supported by a substrate 283 and electrode 281. FIG. 11G shows a polyhedral shape sensor having multiple sensor arrays 290 supported by a substrate 291. FIG. 11H shows a spherical shape sensor having sensor arrays of which arrays 300-303 are shown.

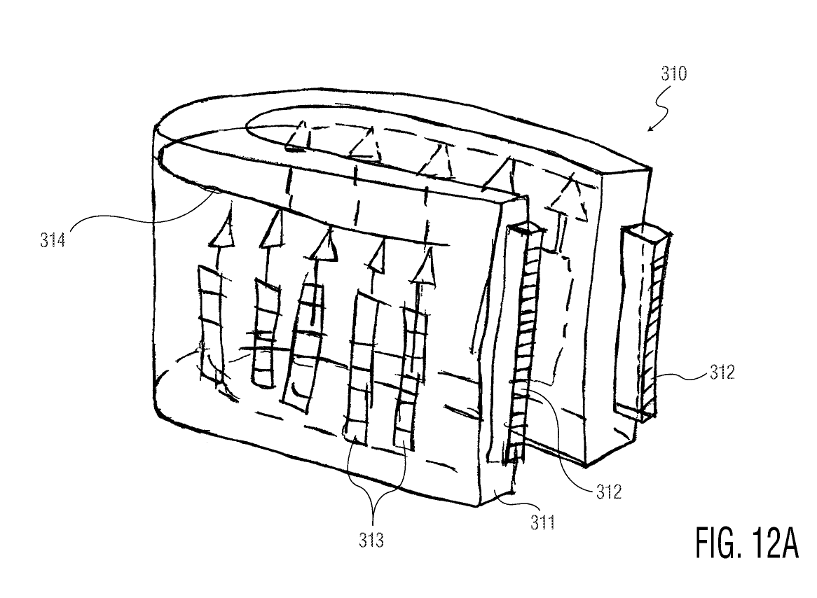

FIG. 12A illustrates exemplary panoramic volumetric sensor array device 310 employing a U-shaped substrate 311 with electrodes 312 on the ends. Sensor arrays 313 form pixel columns around substrate and in communication with readout bus 314. FIG. 12B illustrates further components of device 310 including some of the components and arrangement which make up the exemplary panoramic volumetric sensor array device according to the present invention. For example, a color filter 315, microlenses 316, a glass cover 317, control circuitry 318, image circuitry 319 with an image processor and a fisheye lens 320.

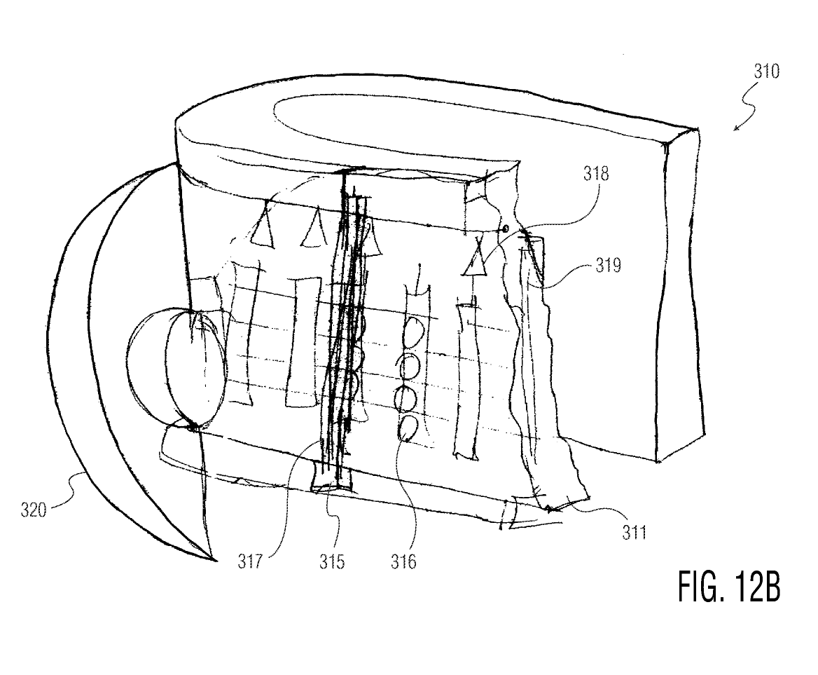

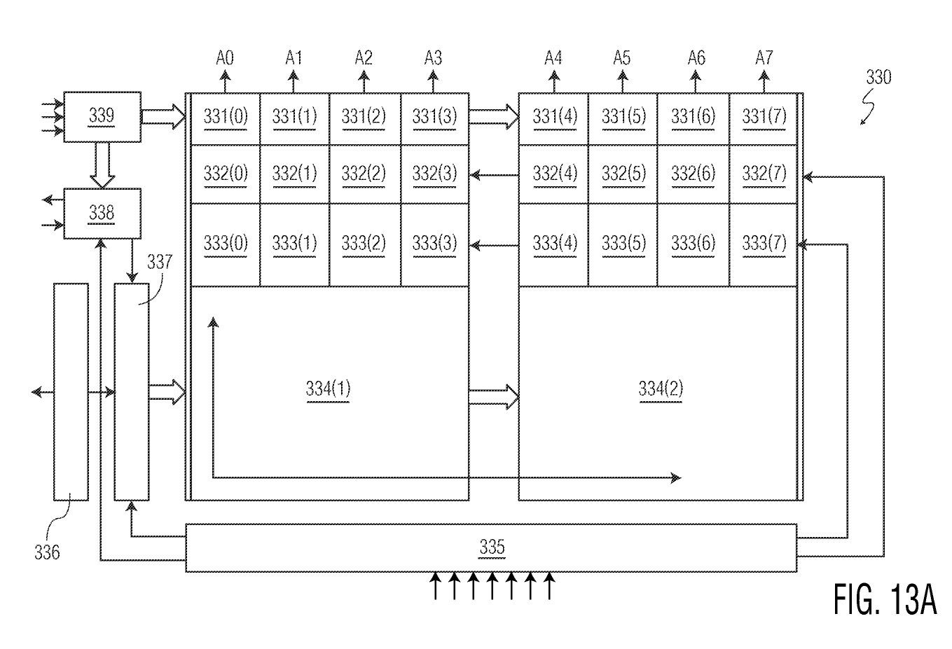

FIG. 13A illustrates a layout of the exemplary panoramic volumetric sensor array device 330 with two discrete areas according to the present invention. Specifically, device 330 employs PGAs 331, 486 PVS-buses 332, and 486 ACS/CDs 333 for two (2) respective 3840×2160 volumetric pixel photodiode arrays 334. Also shown is a timing controller 335 for various signals (e., CLK, VD, HD, P/1, E/1, TEST, TS), a reference generator 336, a row controller 337, an exposure controller 338 and a serial interface 339.

FIG. 13B is similar to FIG. 13A but different embodiment with eight discrete areas of the panoramic volumetric sensor array device according to the present invention.

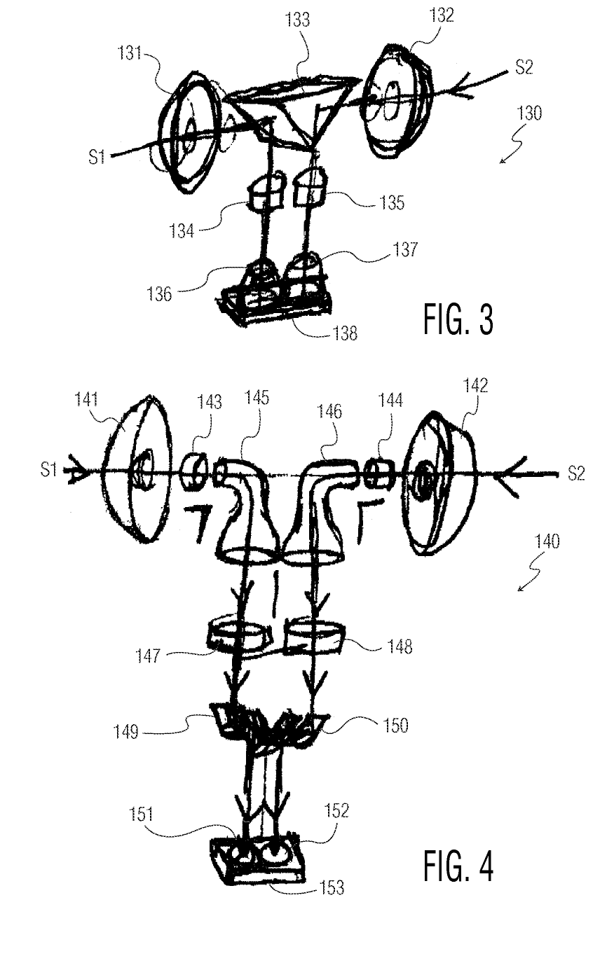

The Michael '245 Patent, the “Oxaal '937 Patent, the Poulo '630 Patent and the “Oh Publication teach various prior art software available to manipulate imagery derived from the panoramic volumetric sensor devices and other panoramic camera arrangements (i.e. FIGS. 3-5) according to the present invention.

As mentioned above, FIG. 1 shows a block diagram of a digital image sensing system, which incorporates teachings of the present disclosure. FIG. 1 is a perspective and diagrammatic view of a panoramic autostereoscopic sensor recording, processing, and display system embodiment representative of the present invention including a computer image display processor/controller 107 and a computer image processor 108 for driving sensors 100,102 to obtain images shown in a video room or reality room 109. A lens array 104, a pixel array 105 and a substrate 106 of sensor 102 correspond to a lens array 110, a pixel array 111 and a substrate 112 of a display of room 109.

The lens system in FIG. 1 is arranged to capture autostereoscopic imagery. That is, the imagery is reflected on the each segment of the sensor 100,102 is interlaced during taking to correspond to the directions from whence each image segment came for autostereoscopic display at a later time in the system process. Examples of the imagery captured, for processing, and display can be seen in prior art as taught by the Guilk '758 Patent, the Ossoinak '176 Patent and the U.S. Patent Publication No. 2003/0107894 to Dolgoff, the entirety of which is hereby incorporated by reference. Alternatively, instead of recording a plurality of adjacent views from different angles of the subject or subject environment as in FIG. 1, a single adjacent FOV coverage of the subject or subject environment may be recorded by the panoramic camera where at least a 90 degree FOV coverage objective lens is incorporated. Still alternatively, fisheye lenses with greater than 180 degree FOV image coverage may provide adjacent overlapping imagery that may be processed later for creating stereo or autosteroscopic imagery. The images are interlaced on each segment by the optical system in the present example in FIG. 1. Alternatively, images may be interlaced manually or by computer image processing well know to those in lenticular, stereoscopic, and autostereoscopic imaging field.

In the present invention a CMOS sensor, such as the QuadHDTV™ high resolution color/monochrome video sensor (hereafter the “Quad sensor”), is incorporated in a novel three dimensional manner, not in a flat rectangular manner. Each side of the sensor may comprise a square array similar to the rectangular array of the Quad Sensor. Each side may be read out as a single channel of video. Or alternately, the array may be bent around such the CMOS, CCD, or PCB device such that a single signal is read out. In either case the arrays surface faces outward in different directions about the volumetric sensor device. And in either case the array regions on the surface may comprise few or many pixels, depending on the resolution desired and manufactured into the panoramic volumetric sensor device. Furthermore, the panoramic sensor device may have curved or flat sides.

The sensor 100,102 is preferably a CMOS or CCD, or some other type of photo detector or photodiode. Manufacturing a CCD sensor typically involves the VLSI process, or very large-scale integration process—a technique used to place hundreds of thousands of electronic components on a single chip. In the CCD manufacturing process, a closely packed mesh of polysilicon electrodes is formed on the surface of a chip. During the operation of a CCD sensor, individual packets of electrons may be kept intact while they are physically moved from the position where light was detected, across the surface of the chip, to an output amplifier. CCD sensors often capture a high quality image, but translating the captured image into the “picture” taken by a CCD-based device often requires several additional chips. A chip or integrated circuit typically refers to a unit of packaged electronic circuitry manufactured from a material like silicon at a small scale or very small scale. A typical chip may contain, among other things, program logic and memory. Chips may be made to include combinations of logic and memory and used for special purposes such as analog-to-digital (A/D) conversion, bit slicing, etc. In some embodiments of a CCD-device, camera functions, like clock drivers, timing logic, as well as signal processing may be implemented in secondary chips. As a result, most CCD cameras tend to have several chips or integrated circuits. CMOS imagers sense light in the same way as CCD imagers, but once the light has been detected, CMOS devices operate differently. The charge packets are not usually transferred across the device. They are instead detected at an early stage by charge sensing amplifiers, which may be made from CMOS transistors. In some CMOS sensors, amplifiers are implemented at the top of each column of pixels—the pixels themselves contain just one transistor, which may also be used as a charge gate, switching the contents of the pixel to the charge amplifiers. This type of sensor may be referred to as a passive pixel CMOS sensor. In active pixel CMOS sensors, amplifiers are implemented in each pixel. Active pixel CMOS sensors often contain at least 3 transistors per pixel. Generally, the active pixel form of CMOS sensor has lower noise but poorer packing density than passive pixel CMOS sensors.

CMOS cameras may also enjoy a relatively high level of integration—in that much of the camera functions may be included on the same chip as the CMOS sensor. In the embodiments of the present invention, the panoramic volumetric sensor array device includes several other components like logic and memory on the chip. For example, as specifically depicted in FIG. 8, a processing engine, which may perform various image processing functions like distortion removal or correction, exposure control, white balance, zoom, and so on is located on chip. Chip circuitry ties the components of the chip together in a communicating relationship. For instance, the image processing engine may be communicatively coupled by circuitry with memory. The combination of process engine and memory may form a processing electronics module, which supports of the two image sensing arrays depicted in the present example. Processing electronics on the chip may also perform other camera related functions like bus management, analog to digital conversion (A/D conversion) or timing and clocking functions. Various image processing and camera management functions may be implemented on-chip with multiple array areas to effectively make a complete one-chip panoramic volumetric camera as described in the present invention.

As mentioned above, key peripheral circuitry, which may include logic, memory, or both, may be integrated onto chip within processing electronics module or elsewhere or as part of a related chipset or printed circuit board. The peripheral circuitry may include a digital signal processing (DSP) core, a timing IC (which may generate timing pulses to drive a sensor), CDS (Correlated Double Sampling noise reduction), AGC (Automatic Gain Control to stabilize output levels), 8-bit A/D converter, etc. Though potentially easier with CMOS-based sensors, the peripheral circuitry may be integrated with either CCD or CMOS sensors. It may be more cost effective when integrating with a CMOS sensor, because the peripheral circuitry may be more easily included on the same chip as the sensor.

In addition to simpler peripheral component integration, CMOS sensor technology may also allow individual pixels to be randomly accessed at high speed. As a result, applications like electronic zooming and panning may be performed at relatively high speeds with an embodiment like system panoramic volumetric sensor array system. As shown, system panoramic volumetric sensor array system has a single instance of image and camera control circuitry, embodied in processing electronics module, supporting both array areas of the panoramic volumetric sensor. Preferably, especially for telecommunications embodiments of the present invention, the array includes region-of-interest processing. This is advantageous for applications in which specific areas of interest are required. As opposed to scanning and/or reading out an entire panoramic scene, addressing and reading out ROI's facilitates reduced bandwidth requirements.

In operation the panoramic volumetric sensor array system, includes selection processing that acts as a gatekeeper or router. The selection processing may be based on parameters input into the memory of the sensor chip. For instance, tracking facial features may be a basis for selection of a ROI by the panoramic volumetric sensor device/system. As illustrated in FIGS. 9A-9C in some situations the chips processor or processors are designed to be capable of simultaneously processing image information from both array areas A and B simultaneously. In other instances, the processor or processors are designed to and will only need to process an image or images from only one portion (i.e. A or B) of the sensor array. As known, the prior art Quad sensor is a high-resolution color or monochrome video image sensor with region-of-interest (ROI) capability of a type that is adapted and/or reconfigured in a method compatible to several improved and volumetric sensors disclosed in the present invention.

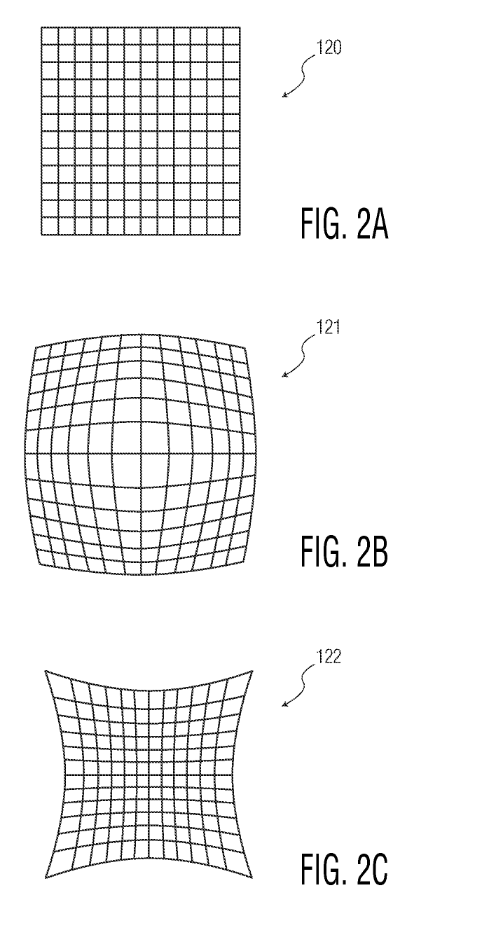

It is important to note that aside from panoramic volumetric sensor systems, prior art panoramic camera systems can be improved just by adding ROI capabilities. Both prior art sensor systems mentioned in this and related disclosures and patents and volumetric sensors in the present invention can benefit from the incorporation ROI and distortion removal techniques. FIGS. 2A-2C respectively illustrate an undistorted image 120, a barrel distortion 121, and a pincushion distortion 122. The Ahisah publication, the Gordon publication and others teach distortion removal techniques incorporated to improve prior art camera designs and volumetric sensor devices in the present invention.

Specifically, the Quad sensor teaches how to provide two adjacent FOV hemispherical barrel distorted images that have been reflected onto a flat rectangular image sensor array with ROI capabilities. The Ahisa publication teaches how to provide two undistorted adjacent FOV hemispherical images reflected upon a flat rectangular image sensor array with ROI capabilities. The Gordon publication teaches how to provide a flat image sensor array where the pixels are masked or located in a pattern which compensates for the distortion of the image cast upon the image sensor in accordance with the present invention, and how to provide a non-planar image sensor array where the pixels are masked or located in a pattern which compensates for the distortion of the image cast upon the image sensor in accordance with the present invention. Of further importance is the Wolfe '429 Patent, the Savoy '992 Patent, the Yamakie '770 Patent, the Kloser '908 Patent, the Quinn '273 Patent, the Hosier '888 Patent, the Prahbu '072 Patent. Additionally, U.S. Pat. No. 6,707,534 to Bjorklund and U.S. Pat. No. 6,849,843 to Ansorge, the entirety of both being herein incorporated by reference.

FIG. 3 is a perspective drawing of the optical components of a panoramic spherical FOV imaging system coupled with an image sensor with ROI processing in order to achieve selective viewing of any portion or portions of the captured hemispherical images that constitute spherical FOV coverage in accordance with the present invention. Specifically, device 130 employs fisheye lens 131,132, a right angle front surface mirror 133, a pair of relay lens 134,135, a pair of fibereys 136,137 and an image sensor 138 (e.g., the Quad sensor).

FIG. 4 is a perspective drawing providing an arrangement optical components using Fibreye ™ to achieve reduced distortion panoramic spherical FOV imaging coupled with an image sensor with ROI processing in order to achieve selective viewing of any portion or potions of the captured hemispherical images that constitute spherical FOV coverage in accordance with the present invention. Specifically, a device 140 employs fisheye lens 141,142, relay lens 143,144, fibereyes 145,146, relay lens 147,148, mirrors 149,150, images 151,152 and an image sensor 153 (e.g., the Quad sensor).

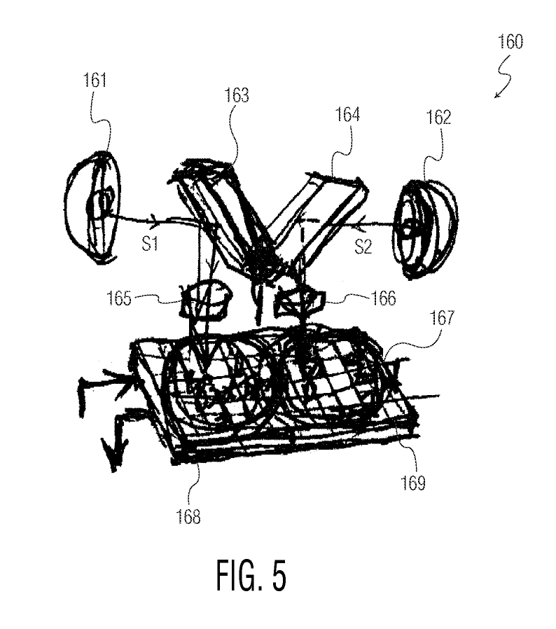

FIG. 5 is a perspective drawing providing an arrangement optical components like that illustrated in FIG. 3, but further including fiber optic image conduits with an off-axis optical path to bend the reflected image toward the image sensor array. Specifically, device 160 employs fisheye lens 161,162, a front surface mirrors 163,164, a pair of relay lens 165,166, images 167,168 and an image sensor 169 (e.g., the Quad sensor).

For a given application seamless or near-seamless views of different scenes and objects may be read out from the panoramic volumetric sensor device. The selection processing may include a recognition system as well as include a ROI processor. For instance, where array area A/or 1 and array area B/or 2 are capturing different views of a common scene, the processor in charge of recognizing and tracking may be capable of determining which array should be selected to capture the desired view based on scanning the signature/ image of the entire spherical FOV composite scene. As shown in FIGS. 6A-24, the panoramic volumetric sensor array system may be incorporated into various camera designs and/or applications. For example, panoramic teleconferencing and surveillance, room display applications, robotic, and medical applications described in this and associated provisional applications.

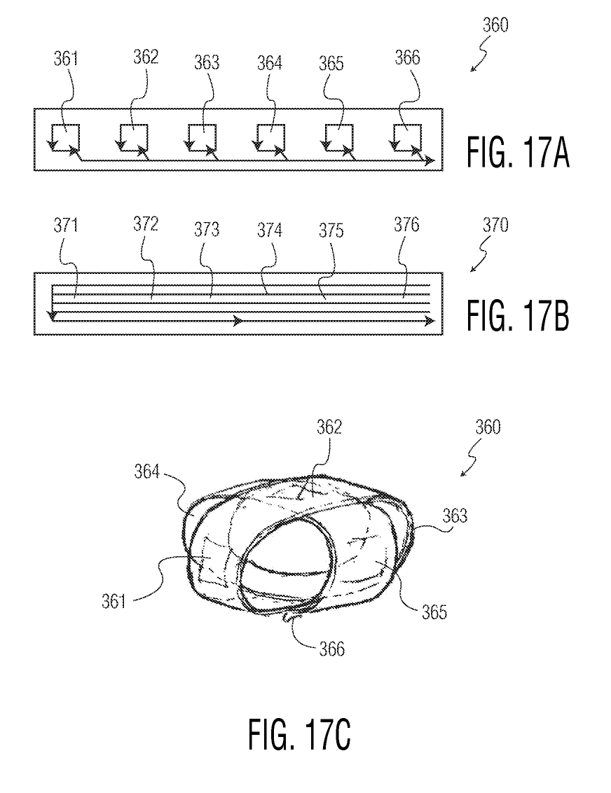

More exemplary, FIG. 14 illustrates a circular volumetric sensor 340, FIG. 15 illustrates a square volumetric sensor 341 and FIG. 16A illustrates a cubic volumetric sensor 350. As related to sensor 350, FIG. 16B shows sensor arrays A-F with microphones 351, and circuitry 352. The PCB of array A-F are folded to form sensor 350 as shown in FIG. 16A. By further example, a sensor 360 having discrete sensory arrays 361-366 can be twisted as shown in FIG. 17C. FIG. 17B shows a sensor 370 having a continuous sensor array 371-376 that may also be twisted.

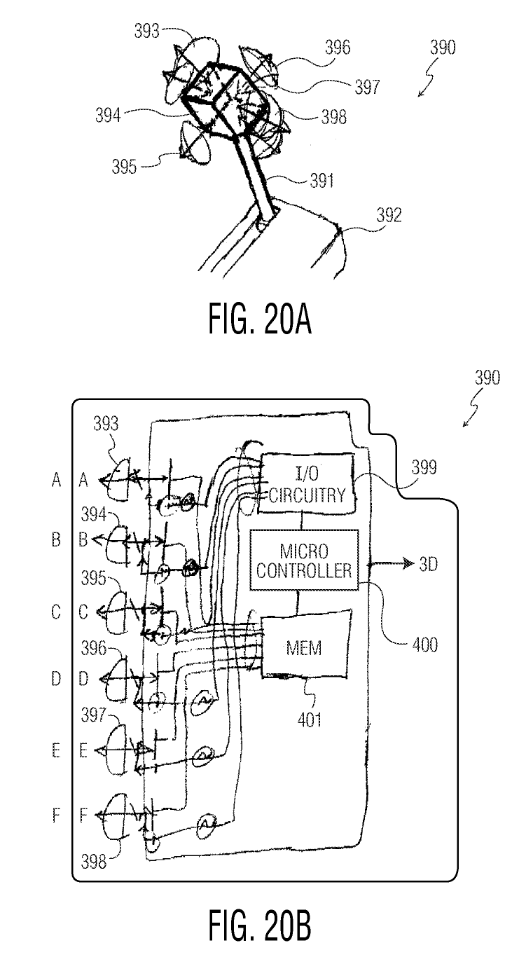

By further example, FIGS. 20A and 20B shows a 3D sensor 390 with a mast 391 extending from system (e.g., a personal communication system, a wireless telephone, a 3D video recorder, etc.) with objective lens 392-398 arranged on respective 3D sensor sides A-F. Also shown is I/O circuitry 399, a microcontroller 400 and a memory 401.

The above examples presuppose that the lenses associated with the two fisheye lenses have adjacent field of view coverage and are fixed wide-angle lenses. However, various camera lenses may be incorporated such as fixed-focus/fixed-zoom, fish eye, panoramic, color, black and white, optical zoom, digital zoom, replaceable, or combinations thereof. A fixed-focus, fixed-zoom lens may be found on a disposable or inexpensive camera module. An optical-zoom lens with an automatic focus may be found on a video camcorder. The optical-zoom lens may have both a “wide” and “telephoto” option while maintaining image focus. Various types of sensor can be used, for example, include motion detectors. Additionally, very small directional microphones may also be integrated into the panoramic volumetric sensor design. In addition to their normal functions, a directional microphone or a motion detector may act as a directional determination assembly that detects a direction of activity in a given scene and outputs a signal that indicates the activity direction. The signal may, in some embodiments, be communicated to the processor that does ROI tracking. Likewise, shape sensors may also be integrated into the panoramic volumetric sensor array design. FIG. 20B is a block diagram, partially diagrammatic view, showing the various improved embodiments of the present invention, specifically CMOS panoramic volumetric sensors which include 3-d shape CMOS sensor(s), 3-d image CMOS sensor(s), and 3-d CMOS audio sensor(s) array(s) and the integration of electronic paper room displays and HMD according to the present invention.

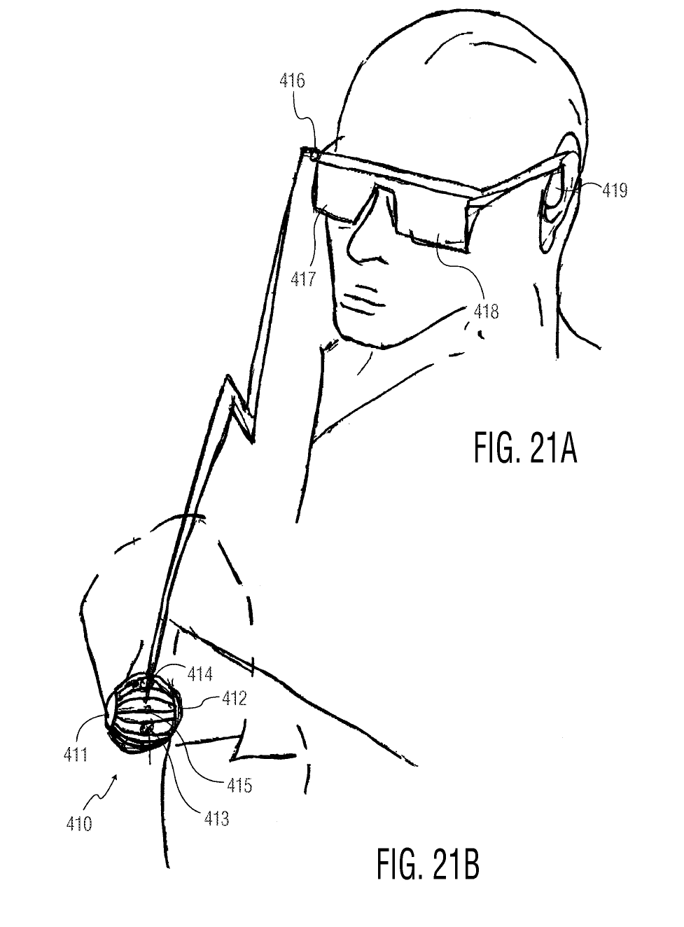

FIG. 21A and 21B illustrates an embodiment of the panoramic volumetric sensor system according to the present invention in which the sensor system has an associated transceiver for telecommunications with a remote processing and/or display device such as a HMD. Specifically, a panoramic volumetric sensor 410 has fisheye lens 411,412, microphones 413, audio-visual transceiver 414 and indicator display 415 The Tanijiri '132 Patent teaches an example HMD system with a receiver generally of a type that is incorporated into the present invention to receive images from the panoramic volumetric sensor described in FIGS. 21A and 21B. This teaching is used for transceiver 414 to communicate with transceiver antenna 416 for the display 417,418 of the video and the playing 419 of the audio.

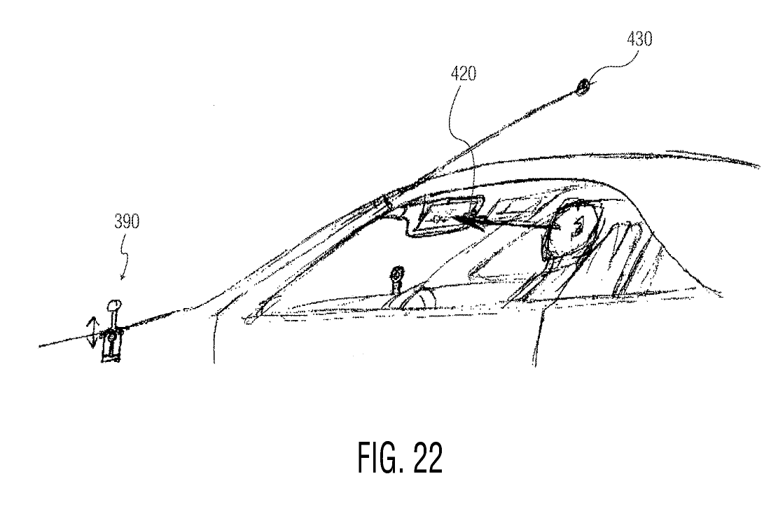

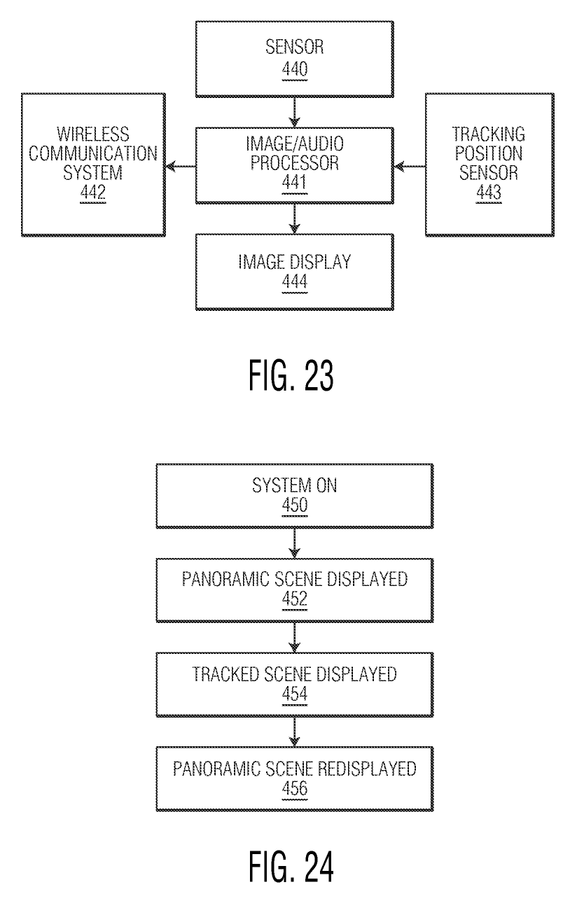

FIGS. 22-24 illustrate various methods of integrating the panoramic volumetric sensor array and other panoramic camera arrangements disclosed in the present invention onto a vehicle. In the example embodiment of the invention as shown in FIG. 22, the driver's visor 420 flips down and has an electronic paper display that displays an image recorded and processed by the panoramic camera system mounted either on the inside or outside of the vehicle. Additionally, in the present example, a shape sensor is used to detect where the driver/user is looking to interactively enlarge a portion of the surrounding environment where the driver is looking at on the display. In this example the spherical image has been unwrapped and displayed on the visor display such that the driver can see a composite 360 degree FOV rectangular scene that represents a visual scene that surrounds the vehicle the driver occupies. FIG. 23 is a block diagram of the system architecture of the panoramic audio-visual system for a vehicle as described in FIG. 22, specifically a sensor 440, an image/audio processor 441, a wireless communication system 442, a tracking position sensor 443, and an image display 444. FIG. 24 is a block diagram of the system algorithms/processes according to the panoramic vehicle audio-visual system as described in FIG. 22 and according to the present invention, specifically system is on at block 450, panoramic scene displayed at block 452, a tracking scene displayed at block 454 and a panoramic scene re-displayed at block 456.

U.S. Pat. No. 6,719,684 to Kim (hereinafter the “Kim '684 Patent”), an entirety of which is hereby incorporated by reference, teaches a prior art pill or capsule that may be digested or inserted with a camera, control unit, power unit, transceiver, and expansion unit of a general type that is adaptable and incorporated into the present invention. A panoramic volumetric sensor array according to an embodiment of the present invention which includes all the components described in the Kim '684 Patent where the expansion unit is un-inflated, but designed to provide panoramic FOV coverage. For example, the pill with a panoramic volumetric sensor array is inside an animals inside cavity and the expansion unit has been inflated such that the array is held in place by the inflated unit at the center of the cavity such that the panoramic volumetric sensor array provide substantially spherical FOV image coverage. And preferably the sensor array has ROI interest readout capability which allows the readout and transmission of specific areas of interest to the doctor or user of the pill/capsule. Further, an endoscope embodiment in which the panoramic volumetric sensor array is situated at the end of a mast that may be inserted into an area for panoramic viewing. Optionally, an expansion unit may or may not be incorporated. And optionally, a transmitter/receiver or wires may be used to read in and out or in electrical power, control and video signals.

U.S. Patent Publication 2004/0176875 to Iribe, U.S. Patent Publication 2004/0236467 to Sano and U.S. Patent Publication 2004/0104702 to Nakadai, the entirety of all hereby being incorporated by reference teach a robot or remotely controlled robot/or vehicle of a type that is incorporated and of a type adaptable to the present invention, and a prior art diagram of a two camera system of prior art used on prior art robots and remotely piloted vehicles as a guidance system for a robot or remotely controlled robot/or vehicle. An embodiment of the present invention in which the panoramic volumetric sensor array that includes 3-d shape CMOS sensor(s), 3-d image CMOS sensor(s), and 3-d CMOS audio sensor(s) array(s) that are integrated and incorporated onto a robot or remotely controlled robot or vehicle to provide signatures that may be processed and used for guidance of the robot or remotely controlled vehicle. Preferably the system includes ROI processing capabilities.

The panoramic volumetric sensor device may be incorporated into various panoramic video teleconferencing or panoramic theater systems. In such systems, the panoramic volumetric sensor system may be coupled with an external computing system. The external computing system is communicatively coupled via an interface to an output of processing electronics. Examples of theater and room-like teleconferencing systems can be found in the prior art. The information sent to the processing electronics of the room and theater systems may be processed again or communicated along to remote computing systems, another videoconferencing device, or a plurality of remote systems and devices.

A prior art example of a distribution system that may be adapted to send panoramic information derived from the panoramic volumetric sensor of the present invention is taught by U.S. Patent Publication No. 2002/0156858 to Hunter (hereinafter the “Hunter '858 Publication”), the entirety of which is hereby incorporated by reference. Instead of sending only single billboard image or images, the distribution system in the Hunter '858 Publication is used to send panoramic images. These may be single images for a single or two displays in the case of a cell phone or HMD system, or may be all sides of a scene for viewing on in a room or theater according to the present invention. Images from the sensors may be viewed on conventional displays, but preferably they are viewed on panoramic/immersive type displays for greatest effect.

As depicted in my earlier related provisional application the information communicated from the volumetric sensor array may be compressed and/or encrypted prior to communication via a circuit-switched network like most wireline telephony networks, a frame-based network like Fibre Channel, or a packet-switched network that may communicate using TCP/IP packets like Internet. The physical medium caring the information could be coaxial cable, fiber, twisted pair, an air interface, other, or combination thereof. In some embodiments, a broadband connection may be preferred and an XDSL modem, a cable modem, an 802.11x device, Bluetooth, another broadband wireless linking device, or combination thereof may be employed.

Panoramic Image Processing and Display: The image or images from the panoramic volumetric sensor or image or images generated therefrom may be presented on a videoconferencing display as a collage of individual ISL images, a split screen image, a panoramic image, or some other and/or configurable display image. The images may be processed to have fields of view that overlap and ensure a panoramic view of the scene that covers 360 degrees.

The Hunter '858 Publication further illustrates various prior art embodiments of large planar billboard and teleconferencing display systems (i.e. LED, electronic paper displays) of a type that are incorporated in the present invention and adapted to form room-like display systems for panoramic viewing consistent and integrated with the processing systems and imaging devices of the present invention.

The Hunter '858 Publication further teaches teleconferencing and billboard use that is adapted to and integrated into the present invention to serve as a distribution system for imagery and audio recorded by volumetric panoramic sensor devices and displayed on room display devices according to the present invention. Referring to the Hunter '858 Publication, a system for direct placement of commercial advertisements, public service announcements and other content on electronic displays. The prior art system includes a network comprising a plurality of electronic displays that are located in high traffic areas in various geographic locations. In prior art the displays may be located in areas of high vehicular traffic, and also at indoor and outdoor locations of high pedestrian traffic, as well as in conventional movie theaters, restaurants, sports arenas, casinos or other suitable locations. Thousands of displays, up to 10,000 or more displays worldwide, may be networked according to the prior art invention. In preferred embodiments of the prior art invention, each display is a large (for example, 23 feet by 33½ feet), high resolution, full color display that provides brilliant light emission from a flat panel screen.

Still referring to the Hunter '858 Publication, in the present art the image or images are sent from a panoramic camera system, preferably a panoramic volumetric camera system previously described in the present invention or associated provisional applications by the same inventors. Several embodiments are possible using the prior art distribution system described in the Hunter '858 Publication when integrated with the panoramic taking, processing, and display system described in FIG. 1 and the various prior art mentioned herein. Each server may receive a complete composite panoramic image and distribute the image across displays that form a room display instead of a billboard display. In other words a single image of spherical FOV coverage may be transmitted from a server and then wrapped around the viewer by using a controller and display units. Or alternatively, a plurality of servers may be located at a single location, and each respective server receives a portion of the composite scene that displayed on an associated display that when placed adjacent to other displays with associated servers form a composite panoramic room display that surrounds the viewer or viewers. In other words a plurality of separate video channels with different channel representing different sides may be sent to a server and then wrapped around the viewer by using controllers and display units.

A customer of the distribution system receiving panoramic video, for example a panoramic video room or reality room theater or teleconferencing center owner, may access a central information processing station of the system via the Internet through a Customer Interface Web Server. The customer interface web server has a commerce engine and permits the customer to obtain and enter security code and billing code information into a Network Security Router/Access module. Alternatively, high usage customers of the system may utilize a customer interface comprising a high speed dedicated connection to module. Following access, the customer reviews options concerning his order by reviewing available movie or teleconferencing time/locations through a Review Schedule and Purchase Time module that permits the customer to see what time is available on any display throughout the world and thereafter schedule and purchase the desired advertising time slot. Next, the customer transmits the advertising content on-line through the Internet, a direct phone line or a high speed connection (for example, ISDN, or other suitable high speed information transfer line) for receipt by the system's Video & Still Image Review and Input module. In parallel, the system operator may provide public service announcements and other content to module. All content, whether still image or video, is formatted in HDTV, IDTV NTSC, PAL, SECAM, YUV, YC, VGA or other suitable formats. In a preferred embodiment, the format is HDTV, while all other formats, including but not limited to HDTV, IDTV, NTSC, PAL and SECAM, can be run through the video converter.

The video & still image review and input module permits a system security employee to conduct a content review to assure that all content meets the security and appropriateness standards established by the system, prior to the content being read to the server associated with each display where the content being transmitted to the server will be displayed. Preferably, the servers are located at their respective displays and each has a backup. An example of a suitable server is the IBM RISC 6000 server.

The means for transmitting content information to the display locations may take a number of forms, with it being understood that any form, or combination thereof, may be utilized at various locations within the network. As taught by the Hunter '858 Publication, the means include:

a. High speed cable

b. Satellite

c. Dedicated phone

d. High speed line (e.g., ISDN, ADSL)

e. Cellular, PCS or other data transmission at available frequencies

f. Internet

g. Radio/radio pulse transmission

h. High speed optical fiber

i. Physical delivery of digitally stored information medium.

A video converter/scalar function and a video controller function provided by module may be utilized in connection with those servers and associated displays that require them, according to data transmission and required reformatting practices well known in the art.

The present invention provides further embodiments; displays may take the form of eight cubic feet or larger seamless screen display room including multiple flat or curved panel display modules/panels. In one embodiment panels utilize advanced semiconductor technology to provide high resolution, full color images utilizing light emitting diodes (LED's) with very high optical power (1.5-10 milliwatts or greater) that are aligned in an integrated array with each pixel having a red, green and blue LED. It will be appreciated that multiple LED's of a given color may be used at pixels to produce the desired light output; for example, three 1.5 milliwatt blue LED's may be used to produce a 4.5 milliwatt blue light output. Each red, green and blue emitter is accessed with 24 bit resolution, providing 16.7 million colors for every pixel. One side of the overall display may be 23 feet by 33½ feet, so constructed, has a high spatial resolution defined by approximately 172,000 pixels at an optical power that is easily viewable when the other sides of the display are illuminated. Suitable display modules for displays are manufactured by Lighthouse Technologies of Hong Kong, China, under Model No. LV50 that utilize, for blue and green, InGaN LED's fabricated on single crystalline Al.sub.2O.sub.3 (sapphire) substrates with a suitable buffer layer such as AlN and, for red, superbright AlInGaP LED's fabricated on a suitable substrate such as GaP. These panels have a useful life in excess of 50,000 hours, for example, an expected life under the usage contemplated for network of 150,000 hours and more.

In preferred embodiments, the panels are cooled from the back of the displays, preferably via a refrigerant-based air conditioning system (not shown) such as a forced air system or a thermal convection or conduction system. Non refrigerant-based options may be used in locations where they produce satisfactory cooling. The displays preferably have a very wide viewing angle, for example, 160.degree.

In addition, any suitable structure may support the display panels and accommodate the processing systems associated with the display panels. Preferably, processing systems are located outside the display space. Control consoles and interactive display devices may be positioned and operated inside or outside of the viewing area or integrated into the display panels themselves. Audio systems may be located inside or outside the viewing space or integrated into the display systems themselves. The display panels or modules may be held against the wall in any conventional manner, such as Velcro, screws, or glue. One preferable application is mounting modular units described herein on the walls of a conventional room in a conventional home to for entertainment or for telecommuting/teleconferencing purposes.

In the case of low ambient light applications, such as room-like digital movie theaters, lower power LED's may be used. Furthermore, higher power LED's may be used to provide a light source for an LCD shutter-type screen as described in U.S. Pat. No. 5,724,062 to Hunter, the entirety of which is incorporated herein by reference. Alternatively, the production distribution system may also be used with electronic paper display systems in the present invention. For example electronic ink displays produced under the IMMEDIA brand by E-Ink Corporation of Cambridge, Mass., USA.

The provision of one or more high resolution, highly aligned digital cameras at each display site, for example the camera or cameras utilized in digital camera and traffic counter and security monitor, or other specifically dedicated cameras, provides a means permitting diagnostics and calibration of the displays. It will be appreciated that advertising content information may be transmitted to the electronic display locations by physically delivering a suitable information storage device such as CD ROM, zip drive, DVD ROM or DVD RAM. This approach may be utilized to transmit information to displays at any desired location, for example, to remote locations, to room-like video movie theaters, etc.

Additionally, the floor arrangement of a type disclosed the Ritchey '506 and '794 Patents may be incorporated into the present invention.

The Blum '617 Publication teaches processes used in image exchange, image display processing, and image dividing processing of billboard display systems that are adapted and integrated in the present invention for processing images for room displays according to the present invention. Additionally, post production process and processes for image segmentation and control disclosed in the Ritchey '506, '794, and '576 Patents may be incorporated into the present invention.

U.S. Patent Publication 2004/0113866 to Oku (hereinafter the “Oku '866 Publication”), an entirety of which is hereby incorporated by reference, is a prior art system of another billboard electronic paper system that is adapted and integrated in the present invention for processing images for room displays according to the present invention. The Oku '866 Publication teaches detail of one electronic paper display panel that is a subset of the entire billboard. The electric configuration of the electronic paper and the display panels/modules will be described below with reference to the block diagram.

The display system comprises at least one control unit, an external input unit, an operation unit, a storage unit, and a communication interface (I/F). The display system is designed to be totally controlled by the control unit. The external input unit is designed to input image data displayed on the electronic paper from a personal computer or another external input device such as a panoramic volumetric camera. The image data input by the external input unit is stored in the storage unit. The panoramic image data accumulated in the storage unit is converted into data of a predetermined format by the control unit and output to the electronic paper through the communication I/F and the connection section.

More specifically, the electronic paper can be used as a sub-display or a printer for the personal computer to which a display is connected. The display system can perform various operations through the operation unit. For example, in this embodiment, transmission or the like of the image data stored in the storage unit to the electronic paper can be operated and designated by operation of the operation unit. In addition, the operation unit can operate and designate re-display or the like of image data which has not been completely operated. Each of the adjacent modules/panels of electronic paper includes communication I/Fs and, a control unit, and a display unit to input image data transmitted from the communication I/F of the unit through the connection section and the communication I/F. The image data input through the communication I/F is input to the control unit, and image data to be displayed is extracted by the control unit and input to the display unit, so that an image is displayed in the display region by the display unit. Display units/modules/panels can be flat according to prior art, or may be curved according to the present invention. The remaining image data, from which the image data to be displayed in the display region by the control unit is extracted, is designed to be transmitted to another sheet of electronic paper or the display system through the communication I/F and the connection section. The control unit includes a nonvolatile memory to store image data to be displayed on the display unit. The image displayed on the display unit can be maintained even if a power supplied from the entire display system controller/image processing unit is blocked.

Referring the Oku '866 Publication, the configuration of image data transmitted from the display system to the electronic paper and communication of the image data will be described below. In the control unit of the display system, image data input from an external device such as an external personal computer or volumetric camera is transmitted through the external input unit and accumulated in the storage unit and is added with additional information and output.

The electronic paper that forms the room has an approximately rectangular shape having a small thickness. While rectangular panels are shown, it is known to those in the art that various display panel/module shapes may be constructed and operated. The electronic paper comprises a plate-like display unit having one entire surface on which a display surface for displaying an image is formed, a female connector used for coupling to an external device including another electronic paper, a female connector, a male connector, and a male connector. In the present example, the display surface of the display unit according to the embodiment has a rectangular shape having A-4 size, and is constituted by an electrophoretic display device. On the upper surface of the display surface of the display unit a pressure-sensitive touch panel is mounted. In this case, the pressure-sensitive touch panel is approximately transparent. An image displayed on the display surface can be seen without specific trouble. On the surface of the pressure-sensitive touch panel, near the upper end in, a mark and a mark indicating display directions of an image obtained by the display unit are printed. More specifically, as described above, the display surface of the electronic paper according to the embodiment has A-4 size. A mode (to be referred to as a “first display mode” hereinafter), in which an image is displayed such that the short-side direction of the display surface is set as the horizontal direction, and a mode (to be referred to as a “second display mode” hereinafter), in which an image is displayed such that the long-side direction is set as the horizontal direction, can be employed.

Display directions of an image in the first display mode are two directions, i.e., a direction in which the vertical direction of the image is normal when the electronic paper is referred to in the state shown in and an opposite direction. In the electronic paper according to this embodiment, the display direction in the first display mode is limited to one direction, and the mark indicates this display direction. Similarly, display directions of an image in the second display mode are two directions. However, in the electronic paper according to this embodiment, the display directions in the second display mode are limited to only one direction in advance; the mark indicates the display direction. On the other hand, the female connector and the female connector have the same specifications, and the male connector and the male connector have the same specifications. The female connectors are generically named as female connectors, and the male connectors are generically named as male connectors. In this case, each of the female connectors can be coupled to the male connector. Electrodes which are electrically coupled to electrodes (three electrodes including a power supply electrode in this embodiment) arranged on the male connector are arranged on the female connector, and a frame portion which can be fitted in the recessed portion of the female connector is formed on the male connector. Therefore, the female connector can be electrically and mechanically coupled to the male connector or a connector having the same specifications as those of the male connector.

The female connector and the male connector are arranged at corresponding positions in the vertical direction on two planes which are parallel to the direction of thickness of the electronic paper and which are opposite to each other. Therefore, when the electronic paper and another electronic paper are coupled to each other through the female connector and the male connector, the upper and lower end positions of the sheets of electronic paper can be caused to coincide with each other, and the display surface of the electronic paper. Therefore, for example, when two sheets of electronic paper are coupled to each other, depending on the combinations between the display surfaces of the sheets of electronic paper an A-3 size (horizontal type) display region can be constituted.

When the sheets of electronic paper are to be coupled to each other, a user couples the sheets of electronic paper to each other such that the directions indicated by the marks of the sheets of electronic paper coincide with each other or such that the directions indicated by the marks of the sheets of electronic paper coincide with each other. Suffice to say, that connecting modules may be designed to run in a horizontal (landscape) or vertical (portrait) manner.

The electronic paper module/panel comprises a control unit for controlling an overall operation of the electronic paper, a drive circuit for generating various signals for driving the display unit to supply the various signals to the display unit, a storage unit serving as a nonvolatile memory for storing various pieces of information, and a connection decision unit for deciding whether or not the corresponding device is electrically connected to the connectors by coupling to another device through the female connectors and the male connectors. The control unit, a touch panel, the drive circuit, the storage, the connection decision unit, the female connector, and the male connector are connected. Therefore, the control unit can perform detection of a depression position for the touch panel by a user, display of various images on the display unit through drive circuit, access to the storage unit, recognition of connection states of an external device to the connectors in units of connectors, and transmission/ reception of various pieces of information between the electronic paper and the external device through the connectors.

The printer comprises a control unit for controlling an overall operation of the printer, an operation unit constituted by a keyboard, a display unit constituted by a liquid crystal display, a drive circuit for generating various signals for driving the display unit to supply the various signals to the display unit, a storage unit serving as a nonvolatile memory for storing various pieces of information, and a male connector having the same specifications as that of the male connector.

The control unit, the operation unit, the drive circuit, the storage unit, and the male connector are connected. Therefore, the control unit can perform detection of an operation state for the operation unit by a user, display of various images on the display unit through the drive circuit, access to the storage unit, and transmission/reception of various pieces of information between the printer and the external device through the male connectors.

As said earlier, display panels/modules may be configured vertically or horizontally. When four sheets of electronic paper constitute an A-2 size (vertical type) display region and in which the printer is connected to the female connector of the electronic paper.

When one image is to be displayed in a display region constituted by a combination of display surfaces in the sheets of electronic paper, an image dividing process for supplying image data expressing the image to the sheets of electronic paper such that the image data is divided in units of display regions of the sheets of electronic paper is performed.

As described in the Blum '671 Publication, the image dividing process executed an image dividing process program is executed in the control unit of the printer when the image dividing process is executed. The program is stored in a predetermined region of the storage unit in advance. In a case in which a horizontal A-2 size image is displayed by the image display system a predetermined information input screen is displayed on the display surface of the display unit through the drive circuit. In the next step, the control unit waits for an input of predetermined information. The information input screen 1 displayed on the display unit by the process in step. A message representing that a user is urged to input various pieces of information is displayed, and, as the names of pieces of information to be input, “specifications of a display image”, “display size of electronic paper”, and “the number of sheets of electronic paper” are displayed together with a rectangular frame for inputting these items. A computer graphics, Digital Video Effects System, and various other production systems can be incorporated into the display system.

When the information input screen is displayed on the display unit a user operates the operation unit to input the specification of an image to be displayed on the image display system, the size of the display surface of the electronic paper in use, and the number of sheets of electronic paper in the corresponding rectangular or room of frames, respectively and then designates an “end” button displayed on the lowest part of the screen. “A-2 horizontal”, “A-4”, and “4” are input as “specification of display image”, and “the number of sheets of electronic paper”, respectively. In this manner, the control unit receives the information input by the user to determine YES in step, and shifts to step.

An information input screen based on information input in step is displayed on the display surface of the display unit through the drive circuit. In the next step, the control unit waits for an input of predetermined information. The information input screen displayed on the display unit by the process in step is shown. As shown in The information input screen according to this embodiment, a message representing that a user is urged to select a transfer direction of display data is displayed, and a coupling state of the electronic paper depending on the information input in step and arrows expressing transfer directions of the display data in the coupling state are typically displayed in units of assumable transfer directions.

The display region is constituted by four sheets of electronic paper each having a display size of A-4 size, in addition to the coupling state, various coupling states such as a state in which all the sheets of electronic paper are horizontally or vertically coupled and a state in which only three sheets of electronic paper are horizontally coupled to each other and the remaining sheet of electronic paper is vertically coupled to any one of the sheets of electronic paper can be employed. However, in this embodiment, in order to avoid complexity, a case in which it is assumed that display regions having standard sizes such as A-3 size and A-2 size are constituted by combinations of the sheets of electronic paper will be described below.

When the information input screen is displayed on the display unit, a user operates the operation unit to select a display region in which a transfer direction depending on the configuration of the image display system is indicated. In the image display system according to this example, as shown in FIG. 51b , since the printer is coupled to the female connector located at the left end of the electronic paper located at the lower left in, a transfer direction located at the upper left in is selected by the user. In this manner, the control unit receives information expressing the selection result of the user to determine YES in step, and the control unit shifts to step.

In step, image data (in this case, image data expressing a horizontal A-2 size image) which is designated by a user in advance and which is stored in a predetermined region of the storage unit in advance is read from the storage unit. In the next step, based on information indicating the transfer direction input in step and image data input in step, display data is formed as described below.

The image data input is divided depending on the coupling state of the sheets of electronic paper. In the image display system, four sheets of electronic paper each having a display size of A-4 size are coupled to each other in the shape of a grid to constitute an A-2 size display region, and the size of an image, which is to be displayed, expressed by the image data input in step is horizontal A-2 size. Therefore, the image data is divided in units of four divided regions obtained by equally dividing the image expressed by the image data by two in the horizontal and vertical directions.

The image data in units of divided regions are sorted in a transfer order of display data based on information expressing transfer directions of the display data input. Indexes indicating a page order (transfer order of display data) are allocated to the sorted image data from the start image data. Finally, to each image data, ‘1’ is related as a default value of an index indicating a page of a transfer destination of the display data, and an index indicating the direction of the longitudinal direction of the display image is related.

When the display data is formed, in the next step, the formed display data is transferred to the coupled electronic paper through the male connector. Thereafter, the image dividing process program is ended.

An image display process executed in each of the sheets of electronic paper will be described below with reference to the Blum '617 Publication, which further teaches a flow chart showing a flow of processes of an image display process program which is always executed by the control unit of the electronic paper. The program is stored in a predetermined region of the storage unit in advance shown. The control unit waits for an input of the display data from the printer or the electronic paper on the previous stage. In the next step, the control unit stores the input display data in a predetermined region of the storage unit. In the next step, it is decided whether or not the display data stored in the storage unit includes image data in which the value of the index P1 and the value of the index P2 are equal to each other. When YES is determined in step the control unit shifts to the next step. In the next step, image data DT in which the value of the index P1 and the value of the index P2 are equal to each is read from the storage unit. In the next step, the image expressed by the read image data DT is displayed on the display surface of the display unit through the drive circuit. In addition, in the next step, the read image data and the indexes P1, P2, and P3 attached to the read image data DT are deleted from the display data. Thereafter the control unit shifts to the next step. In the next step, the information of the index P3 related to the image data DT read in step is read, and the image expressed by the read image data DT is displayed on the display surface such that the longitudinal direction of the display image expressed by the information is equal to the longitudinal direction of the display surface. Then the image data DT deleted from the display data in step is stored in a region different from the region in which the display data of the storage unit is stored. On the other hand, when NO is determined in a step, i.e., when there is no image data DT in which the value of the index P1 and the value of the index P2 are equal to each other, the control unit shifts to another step without executing the unnecessary processes. All the indexes P2 of the display data stored in the storage unit are incremented by ‘1’. In the following step, the display data is read from the storage unit and transferred to the electronic paper of the next stage. Thereafter, this image display process program is ended.

When another electronic paper is connected to a plurality of connectors of the electronic paper except for the connectors to which the display data is input, a plurality of transfer destinations of the display data exist. However, since the transfer destination of the display data is determined in advance, the display data is transferred to only the transfer destination. For example, in the electronic paper at the lower left, the electronic paper is coupled to both the male connectors and in addition to the female connector to which the display data is input. However, in this embodiment, since a transfer direction located at the upper left is selected as the transfer direction of the display data, the display data is transferred to only the electronic paper coupled to the male connector.

At this time, recognition of a transfer destination of the display data in each of the sheets/modules/panels of electronic paper may be realized by presetting the transfer destination of the display data in the corresponding electronic paper by inputting an operation by a user through the touch panel arranged on the electronic paper or the following method. That is, information expressing connectors to which electronic paper of the next stage is coupled in the electronic paper which displays an image expressed by the image data DT is included in the image data DT obtained by dividing the display data formed by the printer such that the information and the image data DT are related to each other, and the information is referred by the sheets of electronic paper.

Subsequently, the same processes as described above are sequentially executed in the electronic paper at the upper right and upper left so that images expressed by all the image data DT transferred from the printer are displayed by the sheets of electronic paper included in the image display system.

In the image display system according to this embodiment, the sheets of electronic paper are arbitrarily coupled to each other to constitute an overall display region. Therefore, depending on a method of forming the display data, the display images on the sheets of electronic paper may be upside down, the direction of the display images may be shifted by 90 degrees, and a display image may be inverted with respect to the display images of the sheets of electronic paper vertically and horizontally adjacent to the corresponding image. Therefore, in the electronic paper according to this embodiment, two functions, i.e., an image rotating function for rotating a display image and an image replace function of replacing the display images of sheets of electronic paper horizontally and vertically adjacent to the corresponding electronic paper with the corresponding electronic paper are set.

The Albert '336 Publication teaches drawings illustrating another prior art electronic paper system generally of a type that is adapted for use in creating a room display system according to the present invention. Other prior art electronic paper display system generally of a type that is adapted for use in creating a room display system according to the present invention is interconnectable panel/module system that may also be interlocked like the one a described in a first example of a room display system according to the present invention. Another prior art illustrates a control system for the electronic paper display system shown generally of a type that is adapted for use in creating a room display system according to the present invention.

The Kononashi Publication teaches yet another electronic paper display system of a type that is integrated into the present invention to form a room or head-mounted display system (HMD) according to the present invention.

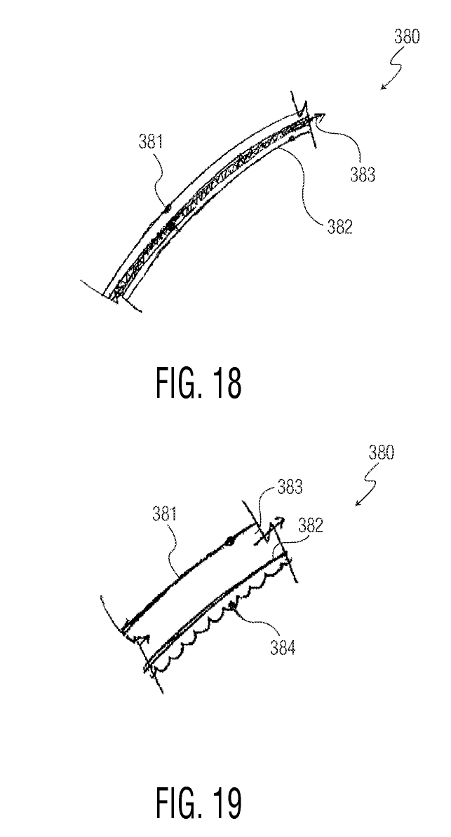

FIGS. 18 and 19 are side sectional views of an electronic paper display 380 according to the present invention that form a surround room or theater that is supported pneumatically. Specifically, display 380 has a opaque flexible backing 381, electronic paper 382, display circuitry 383 and lens 384.

Pneumatic support may be the same as described in the Ritchey '506 Patent.

Prior art control circuit for flexible displays and prior art flexible displays that are of a type incorporated into cellphones, HMD's, and room displays according to the present invention. An example of a pneumatically supported room-like theater that incorporates pneumatically supported electronic paper displays. The electronic paper may be mounted on or integrated into any suitable material used in pneumatic structures such as plastic or canvas.

Prior art optical systems that are placed between the viewer/audience and electronic paper image display to create an impression of three-dimensional autostereoscopic viewing when images are interlaced/segmented on the electronic paper in a specific manner. Images from panoramic volumetric sensor arrays and other panoramic cameras disclosed in this and associated provisional applications are applied to room displays according to the present invention to create a realistic immersive panoramic display system that surrounds the viewer. Interlacing may be accomplished optically during the taking of the image or by image processing. Display of the image is basically done in the opposite manner of optically recording the image.

Previously referenced prior art enables room/theater displays according to the present invention to create a realistic immersive panoramic display system that surrounds the viewer. Images from panoramic volumetric sensor array systems and other panoramic cameras disclosed in this and associated provisional applications by this inventor provide content that is applied for viewing on the room/theater display systems.

Previously referenced prior art further enables a method and layout of offsetting the display to help hide the egress area by displaying a continuous scene as perceived/observed from the viewer/audience's point-of-view.

FIG. 64 is a block diagram of an image segment circuit means of the panoramic display system according to the present invention in which each input source side represents a corresponding side of a cube sided panoramic volumetric sensor that has one QuadHDTV sensor on each side of it's six faces. Each QuadHDTV sensor is an input device, and the image controller divides up each sensors image and sends it to the electronic display panels on that associated side for viewing on the electronic paper panels such that a continuous panoramic scene in the same orientation as taken by the panoramic sensor is displayed. Previously referenced prior art further enables an image segment circuit means of the panoramic display system according to the present invention in which a composite panoramic image from a single input source is divided up by a plurality of image controller units each corresponding to side of a cube sided panoramic volumetric sensor with six faces. The sensor is an input device, and the image controllers divide up the image and send it to the electronic paper display panels for viewing on the electronic paper panels such that a continuous panoramic scene in the same orientation as taken by the panoramic sensor is displayed. Still alternatively, previously referenced prior art further enables image segment circuit means of the panoramic display system according to the present invention in which a composite panoramic image from a single input source is divided up by a first image controller unit corresponding to sides of a cube sided panoramic volumetric sensor with six faces, and then each of the images output from the first image controller is sent to a second image controller where it is divided up again for display on a plurality of electronic paper display panels such that when other panels controlled by other second image controller unit panels a panoramic display system that surrounds the viewer is formed. The sensor is an input device, and a first image controller and second image controllers divide up the image and send it to the electronic paper display panels for viewing on the electronic paper panels such that a continuous panoramic scene in the same orientation as taken by the panoramic sensor is displayed.

Previously referenced prior art further enables a panoramic stereoscopic sensor, recording, processing, and display system embodiment representative of the present invention. The manner in which recorded panoramic images from a six sided image sensor array are segmented by an image controller for display on the electronic paper according to an embodiment of the present invention. Similarly, previously referenced prior art further enables a panoramic stereoscopic sensor, recording, processing, and display system embodiment representative of the present invention. The drawing illustrates the manner in which recorded panoramic images from a two sided image sensor array are segmented by an image controller for display on the electronic paper according to an embodiment of the present invention.

While the present invention has been described with reference to specific embodiments, it will be appreciated that modifications may be made without departing from the true spirit and scope of the invention. It will be apparent to those skilled in the art that the disclosed embodiments may be modified in numerous ways and may assume many embodiments other than the particular forms specifically set out and described herein. Accordingly, the above disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A volumetric sensor assembly, comprising:
a single strip of material twisted into a configuration of light sensitive recording regions facing in a plurality of directions;
optics associated with each light sensitive recording region for recording a panoramic scene; and
a processor operable to read out at least one signal associated with the light sensitive recording regions.

2. A volumetric sensor assembly, comprising:
a single integrated polyhedral shaped device including a plurality light sensitive recording regions incorporated as a single integrated unit;
optics associated with each light sensitive recording region for recording a panoramic scene; and
a processor operable to read out at least one signal associated with the light sensitive recording regions.

3. A volumetric sensor assembly, comprising:
a single integrated circularly shaped device including a plurality of light sensitive recording regions incorporated as a single integrated unit;
optics associated with each light sensitive recording region for recording a panoramic scene; and
a processor operable to read out at least one signal associated with the light sensitive recording regions.
